(19) United States
(12) Patent Application Publication
(10) Pub. No.: US 2023/0419959 A1
(43) Pub. Date: Dec. 28, 2023

(54) INFORMATION PROCESSING SYSTEMS, INFORMATION PROCESSING METHOD, AND COMPUTER PROGRAM PRODUCT

(71) Applicant: KABUSHIKI KAISHA TOSHIBA, Tokyo (JP)

(72) Inventors: Sota WADA, Kawasaki Kanagawa (JP); Daichi HAYAKAWA, Inzai Chiba (JP); Kenji IWATA, Machida Tokyo (JP)

(73) Assignee: KABUSHIKI KAISHA TOSHIBA, Tokyo (JP)

(21) Appl. No.: 18/174,092

(22) Filed: Feb. 24, 2023

(30) Foreign Application Priority Data
Jun. 23, 2022 (JP) 2022-100794

(51) Int. Cl. G10L 15/197; G10L 15/06; G10L 15/28; G10L 15/22; G10L 15/01

(52) U.S. Cl. CPC G10L 15/197; G10L 15/063; G10L 15/28; G10L 15/22; G10L 15/01

(57) ABSTRACT

According to an embodiment, an information processing system includes one or more hardware processors configured to: extract one or more specific expressions representing expressions specific to a domain for which a corpus is to be created, from a domain document belonging to the domain; collect a plurality of pieces of text data including the one or more specific expressions; and select, as the corpus, text data satisfying a predetermined criterion for selecting data belonging to the domain, from the plurality of pieces of text data.

### CROSS-REFERENCE TO RELATED APPLICATIONS

This application is based upon and claims the benefit of priority from Japanese Patent Application No. 2022-100794, filed on Jun. 23, 2022; the entire contents of which are incorporated herein by reference.

### FIELD

Embodiments described herein relate generally to an information processing system, an information processing method, and a computer program product.

### BACKGROUND

For example, speech recognition uses a generic language model learned from a generic corpus consisting of a large amount of text data. When speech recognition is performed for a specific domain, recognition performance can be improved by using, in addition to a generic corpus, a language model (domain language model) learned from a corpus that is specific to the domain (domain corpus).

In addition to speech recognition, language models may also be used to create answer sentences for automatic dialog systems or the like. As such, by creating highly accurate domain corpuses, the processing in these technologies can also be performed with higher accuracy.

### BRIEF DESCRIPTION OF THE DRAWINGS

FIG. 1 is a block diagram of an information processing system according to a first embodiment;

FIG. 2 is a diagram illustrating the outline of a method for calculating the degree of likelihood of occurrence of a recognition error;

FIG. 3 is a diagram illustrating an example of a difference detection process;

FIG. 4 is a diagram illustrating an example of a difference detection process;

FIG. 5 is a diagram illustrating an example of a user interface;

FIG. 6 is a diagram illustrating an example of a method for calculating a measure;

FIG. 7 is a diagram illustrating an example of a method for calculating cosine similarity;

FIG. 8 is a diagram illustrating an example of a user interface;

FIG. 9 is a flowchart of a learning process of the first embodiment;

FIG. 10 is a block diagram of an information processing system according to a second embodiment;

FIG. 11 is a diagram illustrating an example of the relationship between various units and a flow of processing of a recognition device;

FIG. 12 is a flowchart of speech recognition processing of the second embodiment;

FIG. 13 is a diagram illustrating an example of the relationship between various units and a flow of processing of a recognition device;

FIG. 14 is a flowchart of speech recognition processing of the second embodiment; and

FIG. 15 is a hardware configuration diagram of an information processing system according to an embodiment.

### DETAILED DESCRIPTION

According to an embodiment, an information processing system includes one or more hardware processors configured to: extract one or more specific expressions representing expressions specific to a domain for which a corpus is to be created, from a domain document belonging to the domain; collect a plurality of pieces of text data including the one or more specific expressions; and select, as the corpus, text data satisfying a predetermined criterion for selecting data belonging to the domain, from the plurality of pieces of text data.

Referring to the accompanying drawings, a preferred embodiment of an information processing system according to the present invention is now described in detail.

As described above, speech recognition uses a generic language model learned from a generic corpus, for example. A generic language model is robust for commonly used expressions (such as phrases and words). However, expressions that are specific to a certain domain (such as unique phrases and technical terms, hereinafter referred to as “specific expressions”) are often not included in a generic corpus, so that satisfactory recognition performance cannot be achieved. In particular, the recognition performance for specific expressions is extremely important when speech recognition is used for presentations that may include many specific expressions, such as university lectures, academic talks, and meetings on products that include specific product names.

To improve the recognition performance for specific expressions, a method may be contemplated that learns a domain language model using a corpus including specific expressions of the target domain. For example, assuming that speech recognition is performed for the domain of a mathematics lecture at a university, learning a domain language model from the transcribed text data of the speech of the lecture is expected to achieve high recognition performance for the expressions specific to this domain (domain-specific phrases such as mathematical proofs, and technical terms such as mathematical terminology). To perform this method, a sufficient amount of corpus needs to be prepared. However, the work of transcribing the speech of lectures increases the time cost, for example. That is, it is generally difficult to manually collect a sufficient amount of corpus.

One effective technique to solve this problem is a method that creates a domain corpus by extracting, from external large-scale text data, only the text data that has high similarity to domain-related documents such as course materials and lecture materials (hereinafter referred to as “domain documents”). Examples of such methods, creation methods G1 and G2, are described below. Large-scale text data is a large amount of text data collected from external systems, such as the Web, for example. Large-scale text data may be collected in advance and stored in an information processing system 100 (e.g., in a storage unit 221), or it may be stored in another system (such as a storage system) capable of communicating with the information processing system 100.

Creation Method G1

A creation method G1 uses templates created from domain documents to select the text data covered by the templates from large-scale text data as a domain corpus. Each template is a word string that is selected from the domain documents and includes one or more words replaced by a special symbol representing a certain word or a word string. By creating a variety of templates, a sufficient amount of corpus can be created. However, the created corpus may include words and sentences irrelevant to the target domain. Also, the expressions not included in the templates cannot be extracted. Furthermore, large-scale text data often does not include specific expressions, making it difficult to create a domain corpus that includes specific expressions.

Creation Method G2

In a creation method G2, for a topic specified by the user in advance, relevance vectors concerning the topic are calculated separately for a domain document and large-scale text data. Then, by calculating the similarity between the relevance vector for the domain document and the relevance vector for the large-scale text data, the text data relating to the domain document is selected to create a domain corpus. However, the creation method G2 creates the domain corpus from large-scale text data using only the criterion of the similarity to the domain document and therefore may fail to create a domain corpus that includes specific expressions.

### First Embodiment

An information processing system according to a first embodiment first extracts specific expressions from a domain document of the domain for which the corpus is to be created. The information processing system collects text data including the extracted specific expressions from large-scale text data, for example. The information processing system creates, as a domain corpus, the text data that satisfies a certain criterion R1 (predetermined criterion for selecting data belonging to the domain) from the collected text data. This allows for the creation of a domain corpus that includes enough text data including a variety of domain-specific phrases and specific expressions.

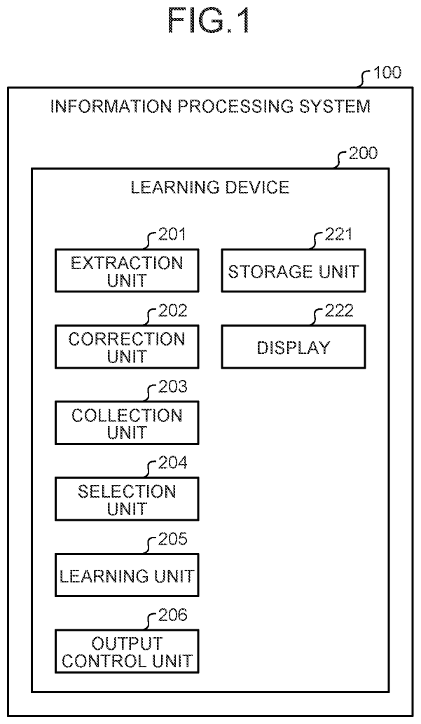

FIG. 1 is a block diagram of an example of the configuration of the information processing system 100 according to the first embodiment. As illustrated in FIG. 1, the information processing system 100 includes a learning device 200.

The learning device 200 is a device that creates a domain corpus and learns a domain language model using the created domain corpus. The information processing system 100 may include a device that performs the process up to the completion of creation of a domain corpus (a creation device) and a device that learns a language model using the domain corpus. When a process using the domain corpus (e.g., learning of a language model) is performed by an external device, the information processing system 100 may include only the function of performing the process up to the completion of creation of a domain corpus (a creation device).

The information processing system 100 (learning device 200) can be implemented by an ordinary computer such as a server device. The information processing system 100 may be configured as a server device in a cloud environment.

The learning device 200 includes the storage unit 221, a display 222, an extraction unit 201, a correction unit 202, a collection unit 203, a selection unit 204, a learning unit 205, and an output control unit 206.

The storage unit 221 stores therein various types of information used by the learning device 200. For example, the storage unit 221 stores therein domain documents and domain language models obtained through learning. The storage unit 221 may be formed by any commonly used storage medium such as a flash memory, a memory card, a random access memory (RAN), a hard disk drive (HDD), and an optical disk.

The display 222 is a display device for displaying various types of information used by the learning device 200. The display 222 may be implemented by a liquid crystal display, a touch panel, and the like.

The output control unit 206 controls the output of various data used in the information processing system 100. For example, the output control unit 206 controls the display of data on the display 222. The data to be displayed includes at least one of the result of extraction by the extraction unit 201 (extracted specific expressions) and the result of selection by the selection unit 204 (selected text data), for example.

The extraction unit 201 extracts specific expressions from the domain document and outputs the specific expressions as a list. The correction unit 202 uses the output control unit 206 to display the list of specific expressions to the user and corrects, if necessary, the list in accordance with the instruction for correction of the list specified by the user, and outputs the list. The collection unit 203 receives the list of specific expressions and collects text data including specific expressions from large-scale text data, for example. The selection unit 204 uses at least one of a measure using the list of specific expressions and a measure using a document relating to the target domain to select text data that satisfies the criterion R1 from the collected text data as a domain corpus. The correction unit 202 further displays to the user text data that is selected by the selection unit 204 or text data that is not selected together with the reason, and corrects, if necessary, the text data according to the correction instruction specified by the user (such as deletion from the domain corpus and addition to the domain corpus). The learning unit 205 learns a domain language model from the domain corpus output by the correction unit 202. Details of each unit are described below.

The above units (extraction unit 201, correction unit 202, collection unit 203, selection unit 204, learning unit 205, and output control unit 206) may be implemented by one or more hardware processors, for example. For example, the above units may be implemented by causing a processor such as a central processing unit (CPU) to execute a computer program, that is, by software. The above units may also be implemented by a dedicated integrated circuit (IC) or other processor, that is, by hardware. The above units may be implemented using a combination of software and hardware. When a plurality of processors are used, each processor may implement one of the units or two or more of the units.

The input to the information processing system 100 is a domain document and the output is a domain language model. The language model may have any configuration. For example, a technique of using N-grams and a neural network may be used. As a neural network, various network configurations can be used, such as a feed forward neural network (FNN), a convolutional neural network (CNN), a recurrent neural network (RNN), and a long short-term memory (LSTM), which is a type of RNN.

The functions of the above units are now described in detail.

The extraction unit 201 extracts one or more specific expressions from a domain document belonging to the domain for which a corpus is to be created, and outputs the specific expressions as a specific expression list. In the present embodiment, it is assumed that a word string that satisfies a certain criterion R2 (predetermined criterion for extracting specific expressions) described below is considered a specific expression. The criterion R2 represents a criterion regarding at least one of (R2_1) a measure indicating the likelihood of occurrence of an expression, (R2_2) a measure indicating whether an expression is widely used in general documents, and (R2_3) a measure indicating the likelihood of occurrence of a recognition error (hereinafter referred to as the degree of likelihood of occurrence of a recognition error). For example, C-value may be used as (R2_1), and perplexity using a generic language model may be used as (R2_2). Each measure is described in detail below.

(R2_1) Measure indicating the likelihood of occurrence of an expression

The present embodiment uses C-value as the criterion (R2_1). Other measures indicating the likelihood of occurrence of an expression include term frequency (TF). C-value is one of the measures for determining which of the collocations (sequential word strings) in a domain document has high importance. C-value is defined by the following Expression (1).

$$C - value ( a ) = \{ \begin{matrix}0 & \begin{matrix}if n ( a ) = n ( {a}^{′} ) , a is a \\ partial word string of {a}^{′}\end{matrix} \\ ( \vert a \vert - 1 ) * n ( a ) & if c ( a ) = 0 \\ ( \vert a \vert - 1 ) * ( n ( a ) - \frac{t ( a )}{c ( a )} ) & otherwise\end{matrix} \qquad ( 1 )$$

a: Collocation
   |a|: Number of component words of “a”
n(a): Frequency of occurrence of “a”
t(a): Total frequency of occurrence of collocations including “a”
c(a): Number of types of collocations including “a”

C-value is a measure for determining the specific-expression characteristic of word string “a” based on the following criteria. The specific-expression characteristic refers to the likelihood of the word string being a specific expression.
A large number of component words of “a” represents higher specific-expression characteristic.
A higher frequency of occurrence of “a” represents higher specific-expression characteristic.
A higher frequency of occurrence of word strings including “a” with a smaller number of types of those word strings represents lower specific-expression characteristic.

(R2_2) Measure Indicating Whether an Expression is Widely Used in General Documents

In addition to C-value, specific expressions may also be selected based on a measure indicating whether a given expression is widely used in general documents. One example of such a measure is perplexity using a generic language model. Other examples of such measures include inverse document frequency (IDF). Perplexity can be obtained by the following Expression (2) using a generic language model learned with a generic corpus.

$$P P = {( P ( {w}_{1} , {w}_{2} , … , {w}_{N} ) )}^{- \frac{1}{N}} \qquad ( 2 )$$

PP: Perplexity
w₁, w₂, . . . , w_{N}: Morpheme string constituting a specific expression
P(w₁, w, . . . , w_{N}): Probability of occurrence of morpheme string w₁, w₂, . . . , w_{N} in the generic language model
N: Number of morphemes constituting a specific expression

In general, an expression that appears frequently in a model has a smaller perplexity, and an expression that appears infrequently in a model has a larger perplexity. In other words, a term (morpheme string) with a large perplexity is less frequent in general documents and has high specific-expression characteristic.

(R2_3) Degree of Likelihood of Occurrence of a Recognition Error

The degree of likelihood of occurrence of a recognition error is a measure for extracting, from the word strings selected using another measure such as C-value and perplexity using a generic language model, word strings that are more likely to be recognized incorrectly in speech recognition. In the following, an example is described in which C-value is used as another measure, but the same procedure can be applied to other measures such as perplexity using a generic language model.

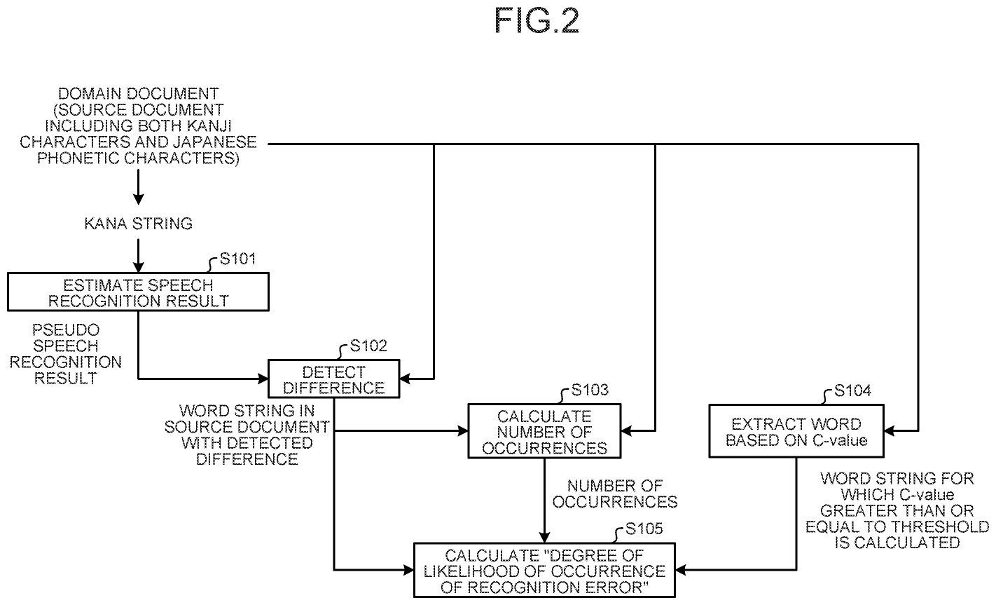

Specifically, the degree of likelihood of occurrence of a recognition error is a measure used to extract, from the word strings in the domain document for which a C-value greater than or equal to the threshold is calculated, word strings that are more likely to be recognized incorrectly by the speech recognition engine when uttered. Referring to FIG. 2, a method for calculating the degree of likelihood of occurrence of a recognition error is now described. FIG. 2 is a diagram illustrating the outline of a method for calculating the degree of likelihood of occurrence of a recognition error.

The extraction unit 201 converts a domain document that includes both Kanji characters and Japanese phonetic characters into strings of kana, the Japanese syllabary. Any method may be used for the conversion, and a method may be used that refers to a dictionary that maps kanji characters to kana.

The extraction unit 201 estimates the speech recognition result using a string of kana assuming that a speech corresponding to the string of kana is input (step S101). The extraction unit 201 can estimate the speech recognition result for an input of the string of kana using the technique described in Japanese Patent No. 6580882, for example.

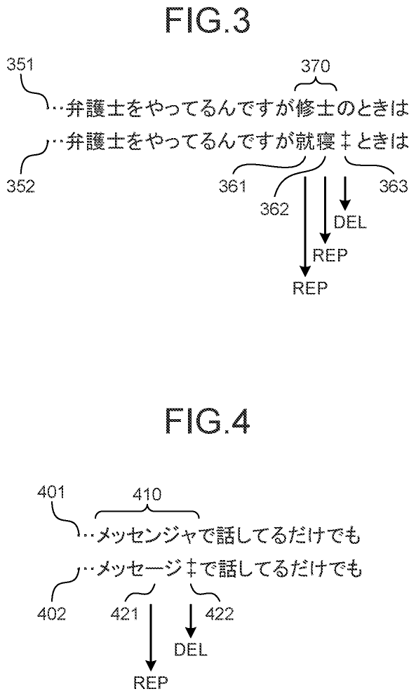

The extraction unit 201 compares the morpheme string of the word string representing the estimated speech recognition result (pseudo speech recognition result) with the morpheme string of the source document (domain document) to detect differences (step S102). This extracts a morpheme string that tends to be recognized incorrectly (difference) from the source document. FIGS. 3 and 4 are diagrams illustrating examples of the difference detection process.

For example, FIG. 3 illustrates an example in which differences are detected from a sentence 351 that means “I am a lawyer, but when I was a master's student”, and a sentence 352 that is the result of pseudo speech recognition. Between the sentence 351 and the sentence 352, characters 361 and 362 and a symbol 363 differ. The symbol 363 indicates that the corresponding character is missing. In FIG. 3, two plus signs (++) are used as the symbol 363. For the differing parts, the extraction unit 201 analyzes whether the character is replaced (REP), whether the character is deleted (DEL), or the like. FIG. 3 illustrates an example in which the characters are replaced at the parts of the characters 361 and 362 and the character is deleted at the part of the symbol 363. The extraction unit 201 extracts a morpheme 370 that means “master” as the morpheme corresponding to a differing part, that is, as a morpheme string that tends to be recognized incorrectly.

FIG. 4 illustrates an example in which differences between a sentence 401 that means “even when you are just talking over Messenger” and a sentence 402 that is the result of pseudo speech recognition. Between the sentence 401 and the sentence 402, a character 421 and a symbol 422 differ. For the differing parts, the extraction unit 201 extracts a morpheme 410 that means “Messenger” as the morpheme corresponding to the differing part, that is, a morpheme string tends to be recognized incorrectly.

Returning to FIG. 2, the extraction unit 201 calculates the number of times the morpheme string detected as a difference is recognized incorrectly (number of occurrences) in the domain document (step S103). The extraction unit 201 extracts from the domain document the word string for which a C-value greater than or equal to the threshold is calculated (step S104).

Based on the morpheme string detected as a difference, the number of occurrences, and the word string for which a C-value greater than or equal to the threshold is calculated, the extraction unit 201 calculates AEscore, which represents the “degree of likelihood of occurrence of a recognition error” using the following Expression (3)

$$AEscore ( w ) = {\sum }_{x} score ( w , x ) \qquad ( 3 )$$

$$score ( w , x ) = \{ \begin{matrix}counts ( x ) & if w = x \\ counts ( x ) * \frac{len ( w )}{len ( x )} & if w ⊂ x \\ \begin{matrix}counts ( x ) * \frac{len ( sub ( w ) )}{len ( w )} * \\ \frac{len ( sub ( w ) )}{len ( x )}\end{matrix} & if sub ( w ) ⊂ x\end{matrix} \}$$

(step S105).
w: Word string for which a C-value greater than or equal to the threshold is calculated
x: Morpheme string of the source document from which the difference is detected
w⊂x: True if morpheme string w is included in morpheme string x
counts (x): Number of times morpheme string x is recognized incorrectly in the document
sub(w): Submorphic string of morpheme string w
len(x): String length of morpheme string x
len(w): String length of morpheme string w

In other words, of the word strings for which C-values greater than or equal to the threshold are calculated, a word that has more parts matching the morpheme string that tends to be recognized incorrectly has a greater “degree of likelihood of occurrence of a recognition error”.

An example of the process flow for extracting specific expressions using the above three measures is now described. The extraction unit 201 extracts specific expressions from a domain document by the following procedure, for example.
(S1) Divide the domain document into morphemes, and extract word strings only.
(S2) Calculate C-value for each word and extract word strings with C-values greater than or equal to the threshold (hereinafter referred to as candidate specific expressions).
(S3) Calculate the perplexity and the degree of likelihood of occurrence of a recognition error of the candidate specific expressions.
(S4) Sort the candidate specific expressions using at least one measure of C-value, perplexity, or degree of likelihood of occurrence of a recognition error, and output the top M₁ (M₁ is an integer greater than or equal to 1) words as a list of specific expressions.

The function of the correction unit 202 is now described. The correction unit 202 corrects the list of specific expressions extracted by the extraction unit 201 and also corrects the selection results by the selection unit 204. Here, the correction of the list of specific expressions is described. The correction of the selection results is described after the description of the selection unit 204. When a correction by the user is not allowed, for example, the correction unit 202 may be configured so as not to include at least a part of its functions (correction of the list of specific expressions, correction of the selection results).

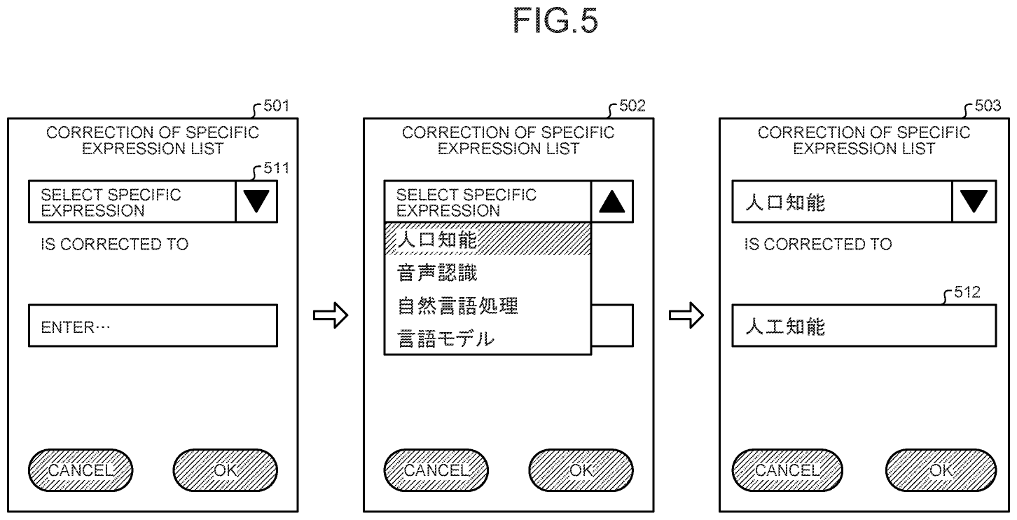

FIG. 5 illustrates an example of the user interface (display screen) used by the correction unit 202 to correct the list of specific expressions. The correction unit 202 displays, using the output control unit 206, a display screen 501 as illustrated in FIG. 5, including the list of specific expressions output by the extraction unit 201. A selection field 511 allows the user to select a specific expression to be corrected from the specific expressions included in the list. A display screen 502 illustrates a state in which a Japanese expression meaning “population intelligence” is selected as the target of correction. A display screen 503 illustrates a state in which that a Japanese expression meaning “artificial intelligence” to which the selected specific expression is corrected is entered into an input field 512.

For example, when the OK button is pressed, the correction unit 202 corrects the list of specific expressions with the data entered into the input field 512 and outputs the corrected list. The correction unit 202 may display on the display screen the reason of the extraction of the specific expression. The content of the reason to be displayed may be a character string including a value of C-value, perplexity, and degree of likelihood of occurrence of a recognition error, for example.

The function of the collection unit 203 is now described. The collection unit 203 receives the list of specific expressions and collects text data including the specific expressions from the large-scale text data. Here, text data including a specific expression may include, in addition to text data including the specific expression itself, text data that includes a part of the constituent words of the specific expression (constituent words forming the specific expression), and text data that includes a specific expression with partially different notation.

The collection unit 203 may collect a certain number of text data pieces in descending order of the number of occurrences of the specific expression or constituent words. For example, when collecting text data including constituent words, the collection unit 203 sorts the large-scale text data according to the number of occurrences of the constituent words and collects the top M₂ (M₂ is an integer greater than or equal to 1) text data.

The function of the selection unit 204 is now described. The text data collected by the collection unit 203 may include text data irrelevant to the domain and text data with a significantly low number of occurrences of specific expressions. Thus, the selection unit 204 selects text data that satisfies a certain criterion R1 from the collected text data as the domain corpus. The criterion R1 represents a criterion regarding at least one of (R1_1) a measure using a list of specific expressions and (R1_2) a measure using a document relating to the target domain (measure using a target domain document). Each measure is described in detail below.

(R1_1) Measure Using a List of Specific Expressions

This measure is a measure representing the extent to which the collected text data includes at least one of the specific expressions and the constituent words of the specific expressions. Specifically, at least one of the number of occurrences (frequency of occurrences) of the specific expression, the rate of occurrence, and TF-IDF is used as the measure.

The rate of occurrence represents the proportion of occurrences of the specific expression, and is calculated, for example, using the number of occurrences of the specific expression relative to the number of words in the text data.

TF-IDF is a technique for converting text data into a vector representation. Expression (4) below indicates a method for calculating TF-IDF when a text t and a word w are given. In general, the higher the importance of the word w in the text t is, the larger the TF-IDF is.

$$\begin{matrix}\begin{matrix}tfidf ( w , t ) = tf ( w , t ) * idf ( w ) \\ tf ( w , t ) = \frac{{n}_{w , t}}{{\sum }_{s ∈ t} {n}_{s , t}}\end{matrix} \\ idf ( w ) = log \frac{N}{df ( w )} + 1\end{matrix} \} \qquad ( 4 )$$

n_{w,t}: Number of occurrences of the word w in the text t
Σ_{sϵt}n_{s,t}: Sum of the numbers of occurrences of all words in the text t
N: Number of documents
df (w): Number of documents in which the word w appears

Using the number of occurrences as an example, the method for calculating this measure is now described in detail. The same procedure can also be applied when the rate of occurrence or TF-IDF is used.

First, the measure that uses the number of occurrences of specific expressions is described. The selection unit 204 measures the number of times each of the specific expressions in the list of specific expressions occurs in the collected text data. Then, the selection unit 204 sorts the collected text data in descending order of the number of occurrences for each specific expression and extracts the top M₃ (M₃ is an integer greater than or equal to 1) pieces. This selects the text data with a large number of occurrences of the specific expressions.

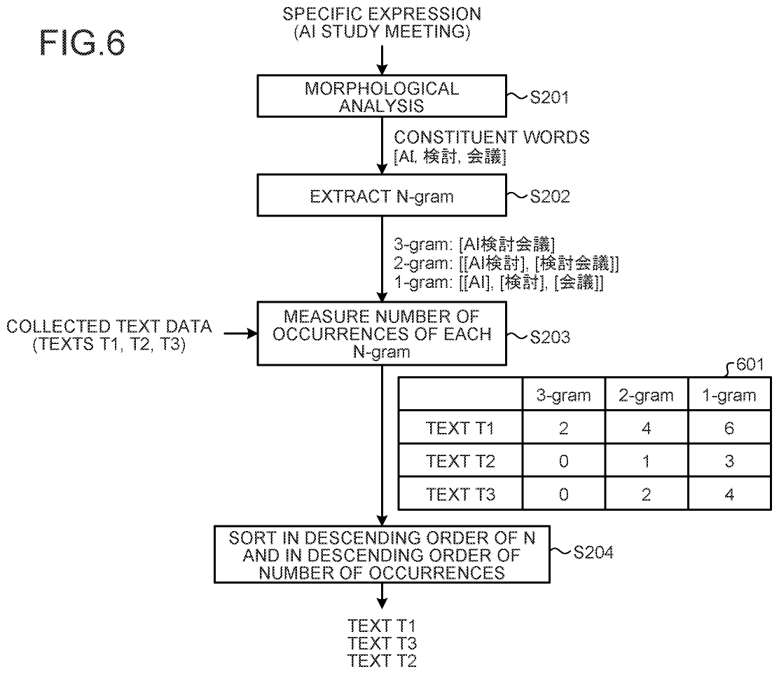

The measure that uses the number of occurrences of the constituent words of a specific expression is now described. As an example, FIG. 6 illustrates a method for calculating the measure in a case where the specific expression is “AI study meeting”.

The selection unit 204 performs morphological analysis to divide the specific expression into units of morphemes to obtain a string of constituent words (step S201). In the example in FIG. 6, the three constituent words of Japanese expressions meaning “AI”, “study”, and “meeting” are obtained.

The selection unit 204 extracts N-grams (N is an integer greater than or equal to 1), which are sequential word strings, from the constituent word strings (step S202). In the example in FIG. 6, 1-gram, 2-gram, and 3-gram are extracted as follows (N=3).
1-gram: a Japanese expression meaning “AI study meeting”
2-gram: a Japanese expression meaning “AI study”, a Japanese expression meaning “study meeting”
3-gram: a Japanese expression meaning “AI”, a Japanese expression meaning “study”, a Japanese expression meaning “meeting”

The selection unit 204 measures the number of occurrences of each N-gram in the collected text data (step S203). Table 601 indicates the measurement result of the number of occurrences for each of the three text data pieces, texts T1, T2, and T3, and for each N-gram.

The selection unit 204 sorts the text data in descending order of N and in descending order of the number of occurrences, and selects the top M₃ text data pieces (step S204). Thus, the text data that includes more constituent words of the specific expression is obtained.

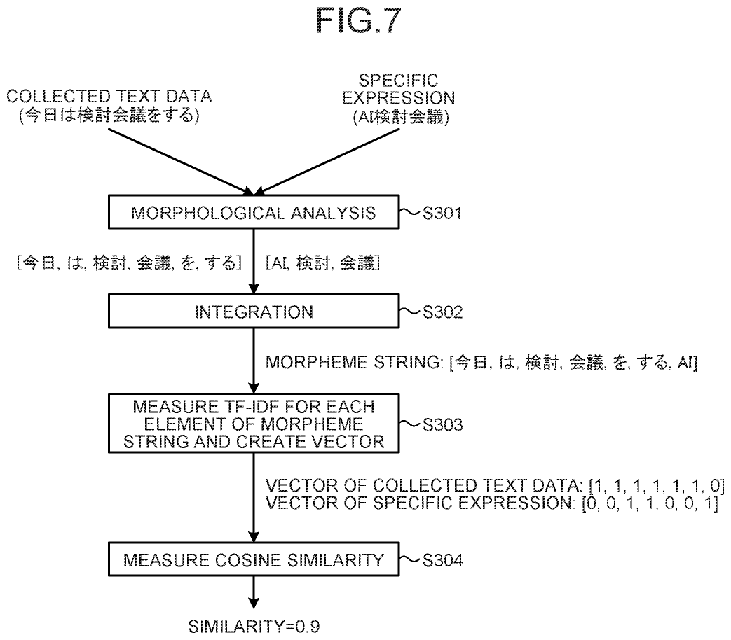

When TF-IDF is used, instead of sorting in descending order of value, a method using cosine similarity may be used. FIG. 7 illustrates an example of a method for calculating cosine similarity. FIG. 7 is an example of the method for calculating in a case where the collected text data is a Japanese expression meaning “We have a study meeting today.” and the specific expression is a Japanese expression meaning “AI study meeting”.

The selection unit 204 performs morphological analysis to divide the collected text data and the specific expression separately into units of morphemes and create morpheme strings (step S301). In the example in FIG. 7, the illustrate morpheme strings are obtained from the text data, and the specific expression.

The selection unit 204 creates a morpheme string that integrates the two morpheme strings (step S302). In the example in FIG. 7, the morpheme string illustrated below step S302 is obtained.

For each element of the integrated morpheme string, the selection unit 204 calculates TF-IDF of the collected text data and the elements of the morpheme string and creates a vector having the calculated values as elements. Similarly, TF-IDF is calculated from the specific expression and the morpheme strings to create a vector. This obtains two vectors whose dimensionality is the number of elements in the morpheme strings (the number of morphemes) (step S303). In the example in FIG. 7, two vectors (1, 1, 1, 1, 1, 1, 0) and (0, 0, 1, 1, 0, 0, 1) are obtained.

The selection unit 204 calculates the cosine similarity between the two vectors (step S304). In the example in FIG. 7, the cosine similarity between the text data of the Japanese expression meaning “We have a study meeting today” and the specific expression of the Japanese expression meaning “AI study meeting” is 0.9.

The selection unit 204 performs this similarity calculation process for each piece of collected text data. The selection unit 204 sorts the collected text data in descending order of similarity and selects the top M₃ text data pieces.

(R1_2) Measure Using a Document Relating to the Target Domain

This measure is a measure that determines the domain of the collected text data and selects text data that is more similar to the target domain. One technique for determining the domain of text data is a method that converts the text data into a vector of fixed length (vectorization) and calculates the similarity to the domain document. The criterion according to this measure is a criterion based on the similarity between the domain document and the text data, which is calculated as described above.

For example, the selection unit 204 converts the domain document into a vector of fixed length (first vector). Similarly, the selection unit 204 converts the collected text data into a vector of fixed length (second vector). The selection unit 204 calculates the similarity (e.g., cosine similarity) of the two vectors. This allows the similarity between the target domain and the collected text data to be determined.

The selection unit 204 sorts the collected text data in order of similarity and selects the top M₃ text data pieces. This allows for the extraction of text data with a high degree of similarity to the target domain. Examples of techniques for converting domain documents and text data into fixed-length vectors include Doc2vec and Word2vec.

As described above, the selection result by the selection unit 204 may be corrected by the user. The function of the correction unit 202 to correct the selection result is described below.

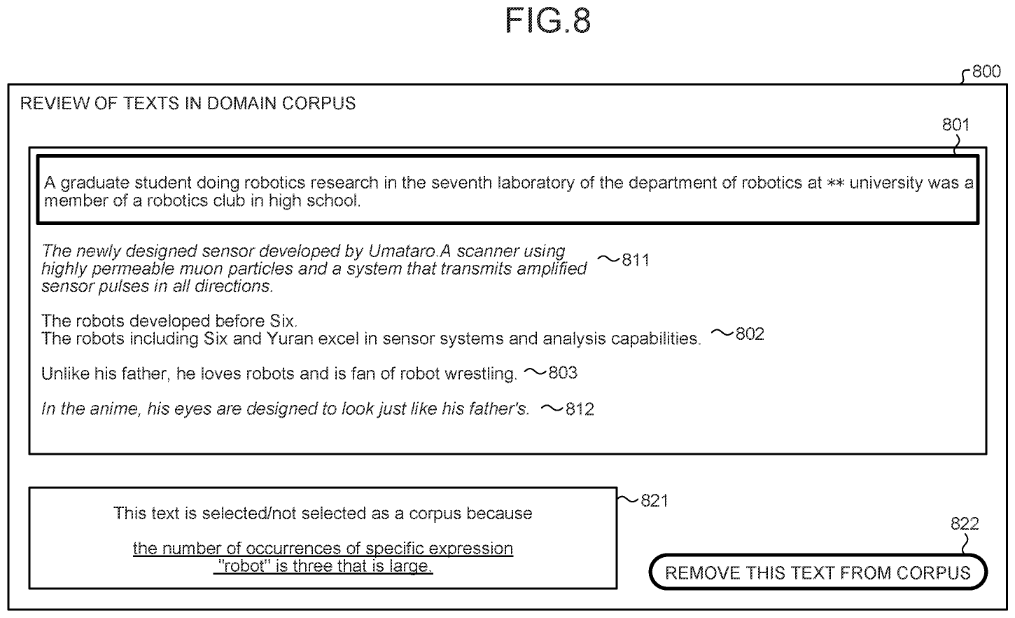

FIG. 8 illustrates an example of the user interface (display screen) used by the correction unit 202 to correct the selected text data. A display screen 800 includes pieces of text data 801 to 803 that are selected by the selection unit 204, pieces of text data 811 and 812 that are not selected by the selection unit 204, a message 821 indicating the reason for selection or non-selection, and a delete button 822.

The selected text data and the unselected text data may be displayed in different display styles. In the example in FIG. 8, the text data that is not selected is displayed in a smaller font size and in italicized text. The display style is not limited to this and may be configured to cause the color to be different (e.g., lighten the color of text data that is not selected).

When text data 801 is specified by the user, for example, the reason for the selection of the specified text data 801 is displayed as the message 821. The delete button 822 is displayed to allow the user to delete text data 801 from the domain corpus. When text data that is not selected (text data 811 and 812) is specified by the user, an add button for adding the specified text data to the domain corpus is displayed in place of the delete button 822.

In this manner, the user can delete text data from the domain corpus and add text data to the domain corpus as needed. The content of the reason displayed as the message 821 may be a character string including numerical values of the measure using a list of specific expressions and the measure using a document relating to the target domain, for example.

The function of the learning unit 205 is now described. The learning unit 205 learns a domain language model using a domain corpus including text data selected by the selection unit 204. The learning unit 205 may perform learning by any conventionally used learning method depending on the format of the language model to be used (such as N-gram language model, neural network language model).

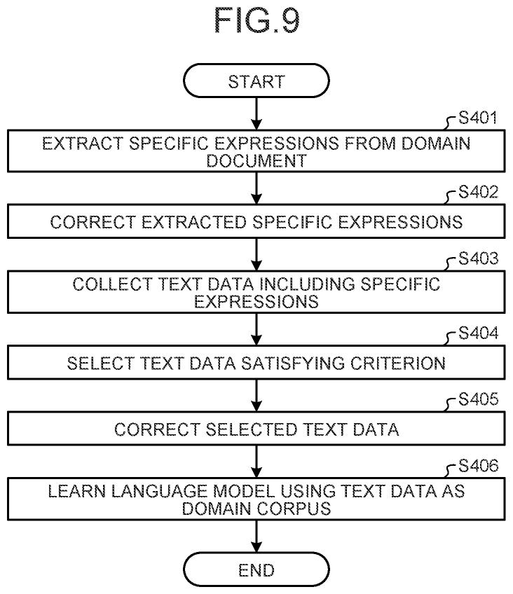

The learning process of the information processing system 100 is now described. FIG. 9 is a flowchart illustrating an example of the learning process of the first embodiment.

The extraction unit 201 extracts specific expressions from a domain document (step S401). The correction unit 202 displays the list of specific expressions using the output control unit 206. When a correction is specified by the user, the correction unit 202 corrects a specific expression according to the correction instruction (step S402).

The collection unit 203 collects text data including the specific expressions from large-scale text data, for example (step S403). The selection unit 204 selects the text data that satisfies the criterion R1 (step S404). The correction unit 202 displays the selected text data using output control unit 206. When a correction is specified by the user, the correction unit 202 corrects the text data according to the correction instruction (step S405).

The learning unit 205 learns a language model using the corrected text data as the domain corpus (step S406) and ends the learning process.

In this manner, the information processing system according to the first embodiment extracts specific expressions from a domain document, collects text data including the extracted specific expressions, and creates a domain corpus of text data that satisfies a certain criterion among the collected text data. This allows for the creation of a corpus specific to the desired domain with higher accuracy.

### Second Embodiment

As a second embodiment, a configuration example that performs speech recognition processing is described as an example of processing using a learned domain language model. As described above, the domain language model can be used not only for the speech recognition processing, but also for processing of create answer sentences for automatic dialog systems or the like.

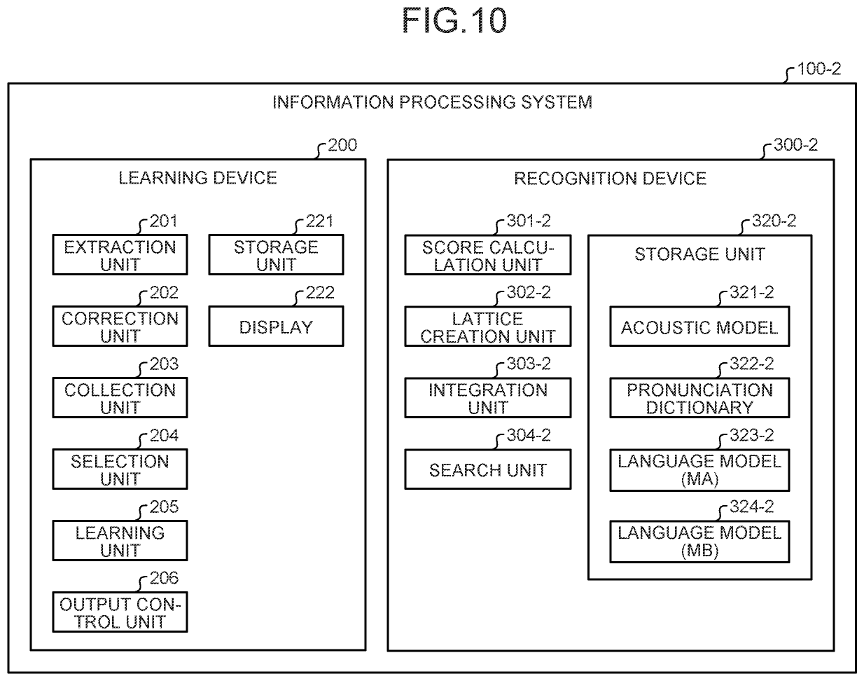

FIG. 10 is a block diagram illustrating an example of the configuration of an information processing system 100-2 according to the second embodiment. As illustrated in FIG. 10, the information processing system 100-2 includes a learning device 200 and a recognition device 300-2 (an example of a recognition unit).

The information processing system 100-2 (learning device 200, recognition device 300-2) may be implemented by an ordinary computer such as a server device. At least one of the learning device 200 and the recognition device 300-2 may be configured as a server device in a cloud environment. When the learning device 200 and the recognition device 300-2 are implemented as different devices, both devices may be connected by a network, such as the Internet, for example.

The configuration of the learning device 200 is the same as in FIG. 1, which is a block diagram of the information processing system 100 according to the first embodiment. As such, the same reference numerals are given, and the description is omitted.

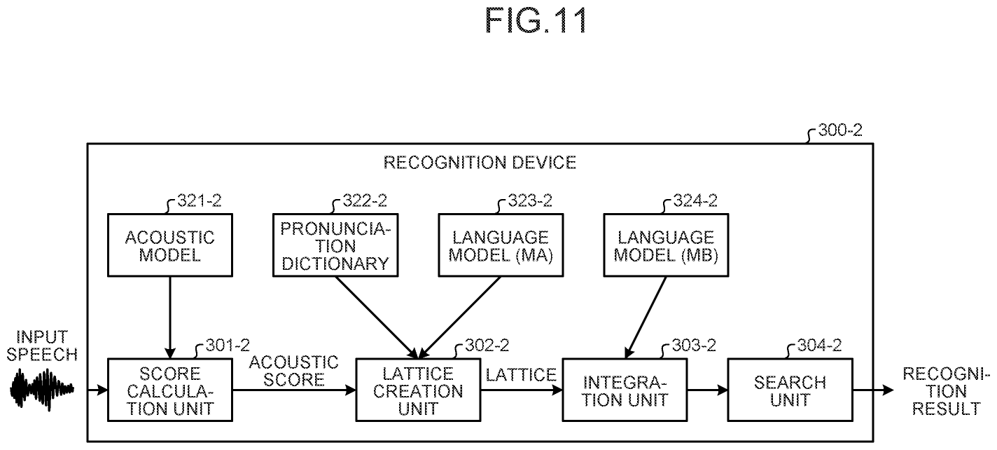

FIG. 11 is a diagram illustrating an example of the relationship between the various units and the flow of processing of the recognition device 300-2. The details of the functions of the recognition device 300-2 are described below with reference to FIGS. 10 and 11.

The recognition device 300-2 is a device that performs speech recognition processing using a learned domain language model. The input to the recognition device 300-2 is a single input speech and the output is the recognition result.

The recognition device 300-2 includes a storage unit 320-2, a score calculation unit 301-2, a lattice creation unit 302-2, an integration unit 303-2, and a search unit 304-2.

The storage unit 320-2 stores therein various types of information used by the recognition device 300-2. For example, the storage unit 320-2 stores therein an acoustic model 321-2, a pronunciation dictionary 322-2, a language model 323-2, and a language model 324-2.

The acoustic model 321-2, which may be a neural network, for example, is a model learned to output the posterior probability of at least one of phoneme, syllable, letter, word fragment, and word based on the collected speech. The output from the acoustic model is hereafter referred to as an acoustic score.

The pronunciation dictionary 322-2 is a dictionary used to obtain words based on acoustic scores.

The language model 323-2 may be a generic language model, for example. The language model 324-2 may be a domain language model learned by and received from the learning device 200, for example. In the following, the language model 323-2 may be referred to as language model MA, and the language model 324-2 may be referred to as language model MB.

The storage unit 320-2 may be configured by any commonly used storage medium, such as a flash memory, a memory card, a RAM, an HDD, or an optical disk.

At least a part of each piece of information (acoustic model 321-2, pronunciation dictionary 322-2, language model MA, language model MB) stored in the storage unit 320-2 may be stored in a plurality of physically different storage media.

The score calculation unit 301-2 obtains an acoustic score, which is the output from the acoustic model, based on the speech collected by a microphone or other speech input device (hereinafter referred to as input speech) and the acoustic model. The input to the acoustic model may be a speech waveform as it is obtained by dividing the waveform of the input speech into frames, or the feature (feature vector) obtained from the speech waveform divided into frames may be used. The feature may be any conventionally used features, such as mel filterbank features, for example. The score calculation unit 301-2 inputs the divided speech waveform or feature vector of each frame into an acoustic model to obtain the acoustic score for each frame.

Based on the acoustic scores, the pronunciation dictionary 322-2, and a language model, the lattice creation unit 302-2 outputs the top candidates of output word strings. For example, the lattice creation unit 302-2 uses the pronunciation dictionary 322-2 to obtain words based on acoustic scores.

The language model is used to output, as a language score, the probability of each candidate utterance of the recognition result consisting of the word strings estimated using the pronunciation dictionary 322-2. The language model may be a generic language model, a domain language model, or an integrated model in which the generic and domain language models are integrated by the integration unit 303-2. When the integration model is not used, the integration unit 303-2 does not have to be provided.

The lattice creation unit 302-2 outputs a fixed number of candidates in descending order of score. Scores are calculated from acoustic scores and language scores. The top candidates output by the lattice creation unit 302-2 are in the form of lattice, with the top candidates of output word strings as nodes and the scores of the top candidate words as edges.

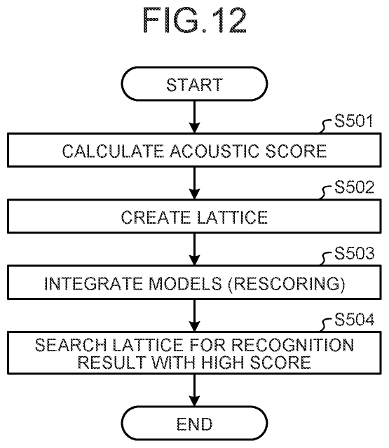

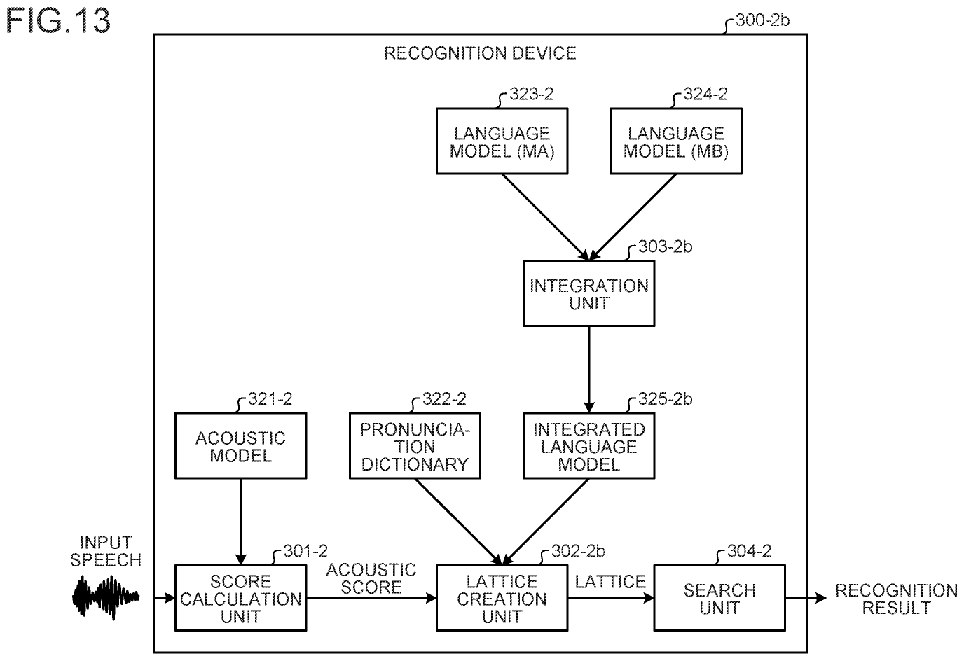

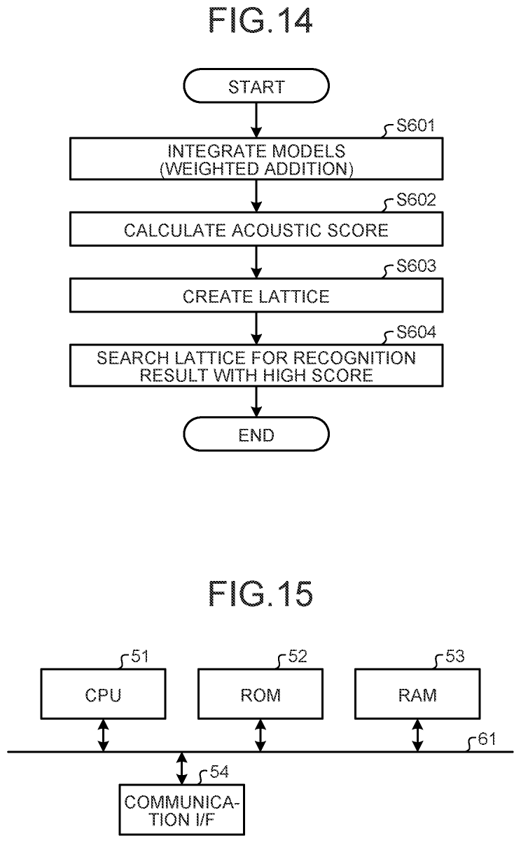

The integration unit 303-2 integrates a plurality of language models, including the domain language model learned by the learning device 200. The integration method may use at least one of rescoring and weighted addition. FIGS. 11 and 12 illustrate an example in which rescoring is used as the integration method. FIGS. 13 and 14 illustrate an example that uses weighted addition.

The search unit 304-2 searches the lattice for the speech recognition result with the highest score and outputs the speech recognition result.

The creation of top candidates for output word strings by the lattice creation unit 302-2 and the search by the search unit 304-2 may use, for example, the method in D. Rybach, J. Schalkwyk, M. Riley, “On Lattice Generation for Large Vocabulary Speech Recognition,” IEEE Automatic Speech Recognition and Understanding Workshop (ASRU), 2017, and any other conventionally used methods.

The above units (score calculation unit 301-2, lattice creation unit 302-2, integration unit 303-2, and search unit 304-2) may be implemented by one or more hardware processors, for example. For example, the above units may be implemented by causing a processor such as a CPU to execute a computer program, that is, by software. The above units may also be implemented by a dedicated IC or other processor, that is, by hardware. The above units may be implemented using a combination of software and hardware. When a plurality of processors are used, each processor may implement one of the units or two or more of the units.

The details of rescoring, which is the integration method used by the integration unit 303-2, are now described.

First, the lattice creation unit 302-2 outputs a lattice including acoustic scores and language scores using the language model MA (generic language model). The integration unit 303-2 rescores the output lattice using the language scores obtained by the language model MB (domain language model). For example, the integration unit 303-2 performs rescoring according to the following Expression (5). The language scores SCA and SCB represent

$$\begin{matrix}S = {S}^{A} + {W}^{L} {S}^{L} \\ {S}^{R} = {S}^{A} + {W}^{RC} {W}^{L} {S}^{L} + {W}^{RD} {S}^{LD}\end{matrix} \} \qquad ( 5 )$$

the language scores obtained by the language models MA and MB, respectively.
S: Score before rescoring
S^{A}: Acoustic Score
W^{L}: Weight for language score SCA
S^{L}: Language Score SCA
S^{R}: Score after rescoring
W^{RG}: Weight for language score SCA for rescoring
W^{RD}: Weight for language score SCB
S^{LD}: Language score SCB

The same method can be applied when three or more language models are integrated. After rescoring, the integration unit 303-2 outputs the lattice with the scores after rescoring.

The speech recognition processing that performs rescoring is now described with reference to FIG. 12. FIG. 12 is a flowchart illustrating an example of the speech recognition processing of the second embodiment.

The score calculation unit 301-2 calculates acoustic scores using the input speech and the acoustic model (step S501). Based on the acoustic scores, the pronunciation dictionary 322-2, and the language model MA, the lattice creation unit 302-2 creates a lattice including the top candidate scores of output word strings (step S502).

The integration unit 303-2 integrates the scores of the language model MA and language model MB by rescoring (step S503). The search unit 304-2 searches the lattice after rescoring for the speech recognition result with the highest score and outputs the speech recognition result (step S504).

The method of integrating a plurality of language models using weighted addition is now described with reference to FIGS. 13 and 14. In the following, it is assumed that the recognition device that performs integration by weighted addition is referred to as a recognition device 300-2b. The recognition device 300-2b differs from the example in FIGS. 11 and 12 above in that an integrated language model 325-2b is added and in the functions of a lattice creation unit 302-2b and an integration unit 303-2b. Since the other configurations are the same, the same reference numerals are given, and the description is omitted.

FIG. 13 illustrates an example of the relationship between the various units and the flow of processing of the recognition device 300-2b when weighted addition is used. The integrated language model 325-2b is a language model that integrates the language model MA and the language model MB, and is stored in the storage unit 320-2, for example.

The lattice creation unit 302-2b differs from the lattice creation unit 302-2 above in that it creates lattices using the integrated language model.

For example, the integrated language model may be a model created by performing weighted addition of the probabilities of occurrence of all words held by each language model. For example, the integration unit 303-2b performs weighted addition and creates an integrated language model, as in Expression (6) below.

Pₘ(w)=W_{g}P_{g}(w)+W_{d}P_{d}(w) (6)

Pₘ(w): Probability of occurrence of word w after weighted addition
W_{g}: Weight for language model MA
P_{g}(w): Probability of occurrence of word w in language model MA
W_{d}: Weight for language model MB
P_{d}(w): Probability of occurrence of word w in language model MB

The same method can be applied when three or more language models are integrated.

The speech recognition processing that performs integration by weighted additions is now described with reference to FIG. 14. FIG. 14 is a flowchart illustrating another example of the speech recognition processing of the second embodiment.

The integration unit 303-2b integrates a plurality of language models (e.g., language models MA and MB) to create an integrated language model (step S601).

The score calculation unit 301-2 calculates acoustic scores using the input speech and the acoustic model (step S602). Based on the acoustic scores, the pronunciation dictionary 322-2, and the integrated language model, the lattice creation unit 302-2b creates a lattice including the top candidate scores of output word strings (step S603).

The search unit 304-2 searches the lattice for the speech recognition result with the highest score and outputs the speech recognition result (step S604).

The integration unit may perform both rescoring and weighted addition. For example, after creating a lattice using the integration model, the integration unit further performs rescoring using a certain language model (e.g., language model MB).

As described above, the information processing system according to the second embodiment can perform speech recognition using a domain language model learned by a domain corpus created by the technique of the first embodiment. This improves the recognition performance of specific expressions in speech recognition.

As described above, the first and second embodiments can create a corpus specific to a desired domain with higher accuracy.

The hardware configuration of the information processing system according to the first or second embodiment is now described with reference to FIG. 15. FIG. 15 is a diagram illustrating an example hardware configuration of the information processing system according to the first or second embodiment.

The information processing system according to the first or second embodiment includes a controller such as a CPU 51, storage devices such as a read only memory (ROM) 52 and a RAM 53, a communication I/F 54 that connects to a network for communication, and a bus 61 that connects the various units.

The computer program to be executed by the information processing system according to the first or second embodiment is provided pre-installed in the ROM 52 or the like.

The computer program to be executed by the information processing system according to the first or second embodiment may be configured to be provided as a computer program product in an installable or executable format file recorded on a computer readable storage medium such as a compact disc read only memory (CD-ROM), a flexible disk (FD), a compact disc recordable (CD-R), a digital versatile disc (DVD), or other computer-readable storage medium.

Furthermore, the computer program to be executed by the information processing system according to the first or second embodiment may be stored in a computer connected to a network such as the Internet, and may be configured to be provided by downloading the computer program via the network. The computer program executed by the information processing system according to the first or second embodiment may also be configured to be provided or distributed via a network such as the Internet.

The computer program executed by the information processing system according to the first or second embodiment can cause the computer to function as the units of the information processing system described above. The computer is capable of executing the computer program, which is read by CPU 51 from a computer-readable storage medium on its main storage device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing system comprising
one or more hardware processors configured to:
extract one or more specific expressions representing expressions specific to a domain for which a corpus is to be created, from a domain document belonging to the domain;
collect a plurality of pieces of text data including the one or more specific expressions; and
select, as the corpus, text data satisfying a predetermined criterion for selecting data belonging to the domain, from the plurality of pieces of text data.

2. The system according to claim 1, wherein the one or more hardware processors are configured to extract the one or more specific expressions from the domain document using at least one of a measure indicating a likelihood of occurrence of an expression, a measure indicating whether an expression is widely used in general documents, and a measure indicating a likelihood of occurrence of a recognition error.

3. The system according to claim 2, wherein the measure indicating a likelihood of occurrence of an expression is at least one of C-value and a word frequency.

4. The system according to claim 2, wherein the measure indicating whether an expression is widely used in general documents is at least one of a perplexity using a generic language model and an inverse document frequency.

5. The system according to claim 1, wherein the one or more hardware processors are configured to collect the plurality of pieces of text data including the one or more specific expressions from a plurality of pieces of text data obtained from a system external to the information processing system.

6. The system according to claim 1, wherein the criterion is a criterion based on a measure representing an extent to which the plurality of pieces of text data include at least one of the one or more specific expressions and constituent words of the one or more specific expressions.

7. The system according to claim 1, wherein the criterion is a criterion based on similarities between the domain document and the plurality of pieces of text data.

8. The system according to claim 7, wherein the similarities are cosine similarities between a first vector obtained by vectorizing the domain document and second vectors obtained by vectorizing the plurality of pieces of text data.

9. The system according to claim 1, wherein the one or more hardware processors are further configured to:
learn a language model using the selected corpus; and
perform speech recognition processing using the language model.

10. The system according to claim 9, wherein the one or more hardware processors are configured to integrate a plurality of language models including the learned language model, using a technique of at least one of rescoring and weighted addition, and to perform speech recognition processing using the integrated language model.

11. The system according to claim 1, wherein the one or more hardware processors are further configured to output at least one of the extracted one or more specific expressions and the text data selected from the plurality of pieces of collected text data.

12. The system according to claim 1, wherein the one or more hardware processors are further configured to correct at least one of the extracted one or more specific expressions and the selected text data.

13. An information processing method executed by an information processing system, comprising:
extracting one or more specific expressions representing expressions specific to a domain for which a corpus is to be created, from a domain document belonging to the domain;
collecting a plurality of pieces of text data including the one or more specific expressions; and
selecting, as the corpus, text data satisfying a predetermined criterion for selecting data belonging to the domain, from the plurality of pieces of text data.

14. A computer program product comprising a non-transitory computer-readable medium including programmed instructions, the instructions causing a computer to execute:
extracting one or more specific expressions representing expressions specific to a domain for which a corpus is to be created, from a domain document belonging to the domain;
collecting a plurality of pieces of text data including the one or more specific expressions; and
selecting, as the corpus, text data satisfying a predetermined criterion for selecting data belonging to the domain, from the plurality of pieces of text data.
